(19) United States
(12) Patent Application Publication
(10) Pub. No.: US 2002/0093619 A1
(43) Pub. Date: Jul. 18, 2002

(54) Liquid crystal display

(76) Inventor: Masamitsu Furuie, Mobara (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/994,705

(22) Filed: Nov. 28, 2001

(30) Foreign Application Priority Data
Nov. 30, 2000 (JP) 2000-364521

(51) Int. Cl. C09K 19/02

(52) U.S. Cl. 349/167

(57) ABSTRACT

There is provided a liquid crystal display device in which low voltage driving and low power consumption are realized. In the liquid crystal display device, a liquid crystal compound layer LC is interposed between a thin film transistor substrate SUB1 and a color filter substrate SUB2. The dielectric an isotropy Δε of the liquid crystal compound layer LC is made 15 or less, the elastic constant K of the liquid crystal compound layer LC is made 8 pN or less, and the maximum value of the liquid crystal driving voltage applied across a pixel electrode IT01 and a common electrode IT02 is made 3 V or less.

### BACKGROUND OF THE INVENTION

1. Field of the Invention

The present invention relates to a liquid crystal display device and, more particularly, to a vertical electric field type of active matrix liquid crystal display device which uses thin film transistors or the like as pixel-selecting switching elements.

2. Background Art

Active matrix liquid crystal display devices using active elements represented by thin film transistors (TFTs) are widely used as display terminals for 0A equipment or the like because of their features of thin size and light weight as well as their high image quality which compares with Braun tubes.

Display methods for such liquid crystal display devices are generally classified into the following two methods. One of the methods is a vertical electric field mode (TN mode) in which a liquid crystal compound layer (hereinafter referred to as the liquid crystal layer or simply as the liquid crystal) is interposed between two substrates (transparent glass substrates or the like) on each of which transparent electrodes are formed, and the molecular orientation direction of this liquid crystal layer is varied by voltages applied to the transparent electrodes, whereby light which enters the liquid crystal through the transparent electrodes is modulated to display an image. Currently, a significant number of popular products adopt the vertical electric field mode (TN mode). The other method is an in-plane switching mode (IPS mode) in which pixel electrodes and common electrodes (counter electrodes) are formed on one substrate with color filters being formed on the other substrate, and a liquid crystal layer is interposed between both substrates, whereby electric fields approximately parallel to a surface of the former substrate are formed between the pixel electrodes and the common electrodes to vary the molecular orientation direction of the liquid crystal layer.

In many cases, since such a liquid crystal display device is used in personal computers or mobile terminals (PDAs), how to reduce its power consumption has been a problem to be solved. One means for reducing the power consumption of the liquid crystal display device is to lower the driving voltage of the liquid crystal in its liquid crystal panel.

To lower the driving voltage of the liquid crystal, it is necessary to increase the dielectric anisotropy Δε of a material which constitutes the liquid crystal. However, if dielectric anisotropy Δε of the liquid crystal material is increased to lower the driving voltage, the power consumption is reduced by the lowering of the driving voltage, but the effect of lowering the power consumption becomes small owing to an increase in power consumption due to an increase in the volume of the liquid crystal.

In addition, if the dielectric anisotropy Δε of the liquid crystal material is increased, the resistivity (i.e., the voltage retention) of the liquid crystal easily lowers, and defective display easily occurs. This has been a problem to be solved.

### SUMMARY OF THE INVENTION

An object of the invention is to provide a liquid crystal display device in which low voltage driving and low power consumption are achieved by solving the above-described problem of the related art.

To achieve the above object, the dielectric anisotropy Δε of a liquid crystal material is increased to impart steep characteristics to the voltage-luminance characteristics of the liquid crystal, there by ensuring sufficient contrast (1:300 or more, at least 1:200 or more) in spite of low driving voltage. The driving voltage is made 4-3 V or less, preferably 2.5 V or less.

In addition, the twist angle of the liquid crystal is made larger than 90° used in the related art, thereby making steep the voltage-luminance characteristics of the liquid crystal to realize low voltage driving similar to the above-described one. Incidentally, because viewing angle characteristics are degraded if the twist angle is made excessively large, the twist angle is made 90°<θ≦100°.

By reducing the dielectric anisotropy Δε of the liquid crystal material to 15 or less, an increase in liquid crystal volume is restrained to reduce an increase in power consumption due to an increase in liquid crystal volume. If the dielectric an isotropy Δε of the liquid crystal material is 15 or less, the polarity of the liquid crystal does not become excessively large, whereby it is possible to rest rain the occurrence of defective display due to a decrease in the resistivity of the liquid crystal.

Furthermore, by using a liquid crystal whose elastic constant K is small, it is possible to obtain steep voltage-luminance characteristics without increasing the dielectric anisotropy Δε of the liquid crystal material. The elastic constant K (hereinafter pN) of the liquid crystal is defined as K=K₁₁+(K₃₃−2K₂₂)/4, where K₁₁ is a spray elastic constant, K₂₂ is a twist elastic constant and K₃₃ is a bend elastic constant.

Although the elastic constant K of the liquid crystal of an ordinary TN type of thin film transistor liquid crystal panel is about 10 pN, the invention uses 8 pN or less. Incidentally, the elastic constant K is preferably 7 pN or less, but since an excessively small elastic constant K lowers the response speed of the liquid crystal, 4 pN or more is preferable.

The invention is not limited to the above-described construction nor the constructions of embodiments which will be described later, and can also be applied to various liquid crystal display devices such as the above-described IPS type and an existing simple matrix type and it goes without saying that various modifications can be made without departing from the technical ideas of the present invention.

### BRIEF DESCRIPTION OF THE DRAWINGS

The invention will become more readily appreciated and understood from the following detailed description of preferred embodiments of the invention when taken in conjunction with the accompanying drawings, in which:

FIGS. 1A, 1B and 1C are cross-sectional views showing the essential portions of a liquid crystal panel which constitutes one embodiment of the liquid crystal display device according to the invention;

FIG. 2 is an explanatory view of the liquid crystal driving voltage and the relative transmissivity of each liquid crystal material used in the embodiment of the invention and those of an ordinary liquid crystal material which has heretofore been used;

FIG. 3 is an explanatory view showing, in terms of the twist angle of a liquid crystal, the liquid crystal driving voltage and the relative transmissivity of a liquid crystal material used in the embodiment of the invention and those of the ordinary liquid crystal material which has heretofore been used;

FIG. 4 is an explanatory view showing the relationship between a driving voltage parameter DVP of a liquid crystal material and the measured value of a driving voltage;

FIG. 5 is an explanatory view showing the relationship between the driving voltage parameter DVP and the dielectric anisotropy Δε of the liquid crystal material;

FIGS. 6A and 6B are plan views showing the construction of the periphery of one pixel of a liquid crystal panel which constitutes the liquid crystal display device according to the invention;

FIG. 7 is a cross-sectional view taken along line IV-IV of FIG. 6A;

FIG. 8 is a cross-sectional view taken along line V-V of FIG. 6A;

FIG. 9 is a cross-sectional view taken line VI-VI of FIG. 6A;

FIG. 10 is a developed perspective view for explaining a specific example of the construction of the liquid crystal display device according to the invention;

FIG. 11 is a front view and a side view of the liquid crystal display device according to the invention; and

FIG. 12 is an explanatory view of the construction and the driver system of a general liquid crystal display device to which the invention is applied; and

FIG. 13 is a view of the external appearance of a notebook personal computer which is one example of an electronic apparatus having a liquid crystal display device according to the invention.

### DETAILED DESCRIPTION OF THE INVENTION

An embodiment of the invention which constitutes one example of a TN type of liquid crystal display device will be described below in detail with reference to the drawings of the embodiment.

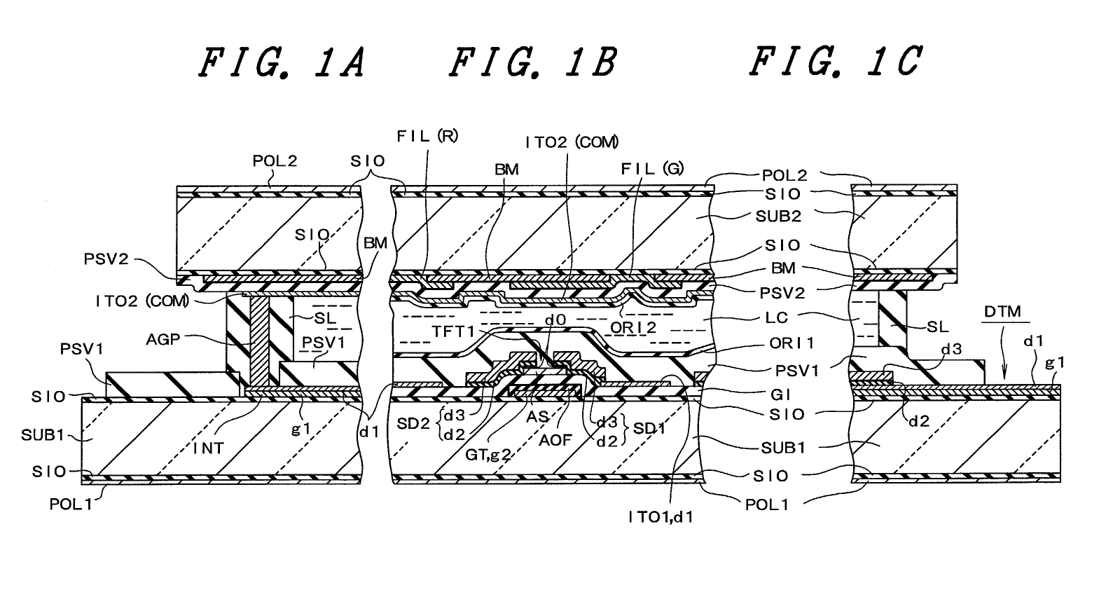

FIGS. 1A, 1B and 1C are cross-sectional views showing the essential portions of a liquid crystal panel which constitutes one embodiment of the liquid crystal display device according to the invention. FIG. 1A shows a side end where gate drivers are mounted, FIG. 1B shows a pixel area (display area), and FIG. 1C shows a side end where drain drivers are mounted.

A liquid crystal layer LC is interposed between one substrate (hereinafter referred to as the thin film transistor substrate) SUB1 and another substrate (hereinafter referred to as the color filter substrate) SUB2.

Pixel electrodes IT01, each of which is driven by a thin film transistor TFT, other electrodes/lines, a lower alignment film ORI1 and the like are formed on the inside surface of the thin film transistor substrate SUB1. Color filters FIL for three colors (color filters FIL(R), FIL(G) and FIL(B) (the color filter FIL(B) is not shown)) which are separated from one another by a black matrix BM, counter electrodes IT02 (COM), an upper alignment film OR12 and the like are formed on the inside surface of the color filter substrate SUB2. Silica layers SI0 which respectively lie on the inside and outside surfaces of each of the substrates SUB1 and SUB2 are disposed for improving the degrees of smoothness of the respective surfaces of the substrates, and are not needed if the substrates themselves are sufficiently smooth.

The thin film transistor TFT is made of a gate electrode GT, a semi conductor layer AS, a drain elect rode SD2 and a source electrode SD1 which is connected to the corresponding one of the pixel electrodes IT01. A gate terminal GTM, which is led from a gate line connected to the gate electrode GT, and a drain terminal DTM, which is led from a drain line connected to the drain electrode SD2, are disposed at the exterior of a seal SL. A voltage for a common electrode IT02 (COM) is applied from the thin film transistor substrate SUB1 via an anisotropic conductive layer CDP.

Incidentally, sign GI denotes a gate insulating film, signs PSV1 and PSV2 respectively denote passivation layers, and signs POL1 and POL2 respectively denote a lower polarizer and an upper polarizer which are arranged in a so-called crossed-Nicols manner in which their polarizing axes are shifted from each other by 90°. Signs d1, d2, d3, g1 and g2 denote, respectively, conductive layers which constitute various kinds of electrodes and lines, and electrodes or lines denoted by the same sign are formed of the same material.

The alignment films ORI1 and OR12 are subjected to so-called rubbing treatment so that their respective rubbing directions intersect each other at 90° with the thin film transistor substrate SUB1 and the color filter substrate SUB2 being stuck together. The polarizing axis of the lower polarizer POL1 and the rubbing direction of the lower alignment film ORI1 are made the same as each other, and the polarizing axis of the upper polarizer POL2 and the rubbing direction of the upper alignment film ORI2 are made the same as each other.

The liquid crystal LC is injected through an injecting port opened in a portion of the sealing material SL, and the injecting port is sealed with an ultraviolet-curing resin.

In the construction shown in FIGS. 1A to 1C, the power consumption W (mW) of the liquid crystal panel can be approximated by the product of a volume C_{LC} of the liquid crystal LC and the square of a driving voltage V_{SIG} as expressed by the following expression (1):

W∝C_{LC}·V_{SIG}². (1)

Therefore, one method of reducing the power consumption W is to reduce the liquid crystal driving voltage V_{SIG}.

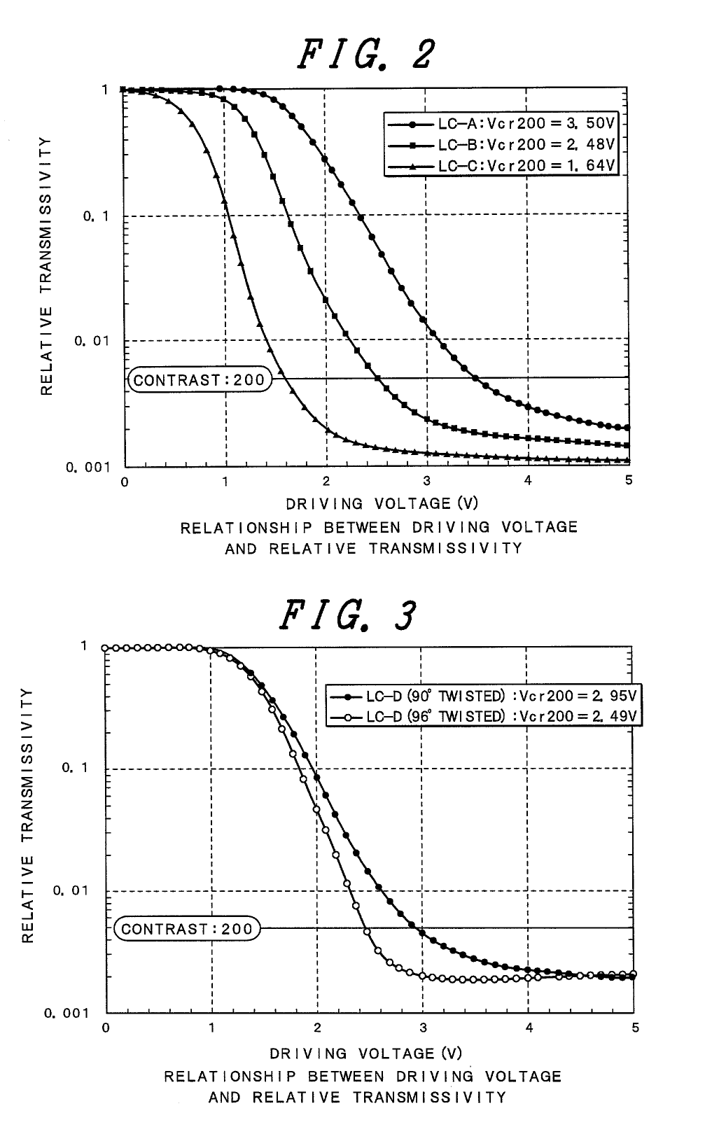

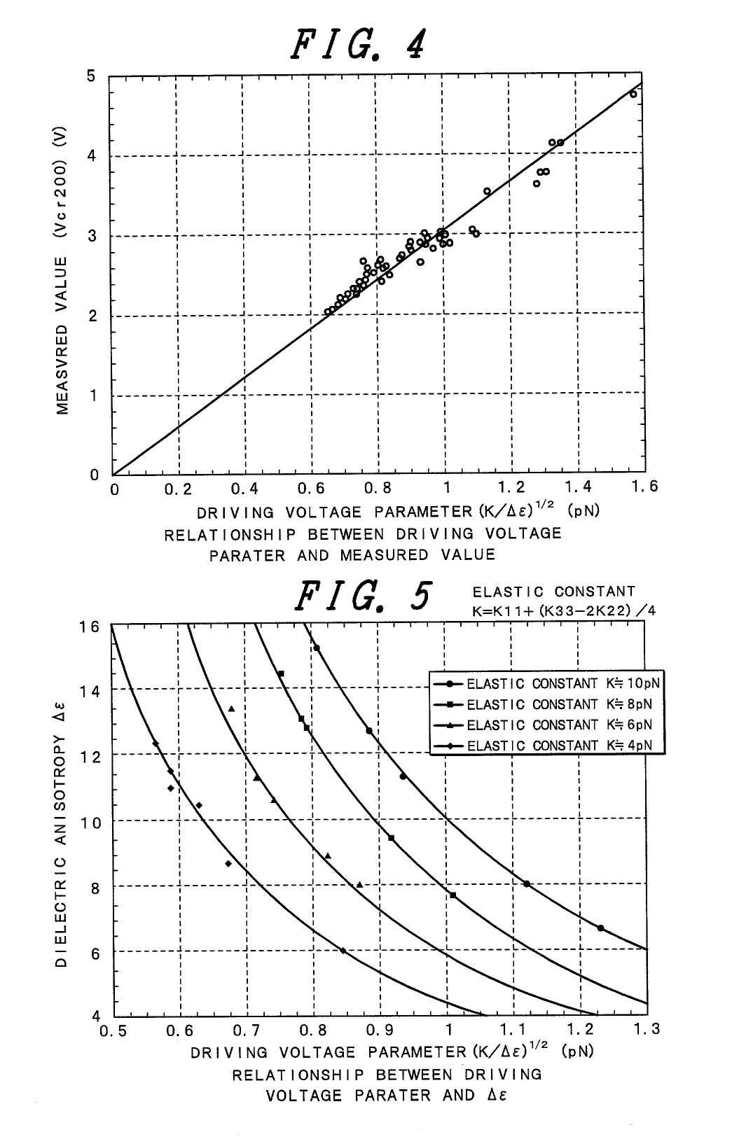

FIG. 2 is an explanatory view of the liquid crystal driving voltage and the relative transmissivity of each liquid crystal material used in the embodiment of the invention and those of an ordinary liquid crystal material which has heretofore been used. In the horizontal axis, V indicates the liquid crystal driving voltage V_{SIG}, while the vertical axis indicates a relative transmissivity plotted against a variation in the liquid crystal driving voltage V_{SIG} (V), where 1 indicates the transmissivity obtained when no liquid crystal driving voltage is being applied.

In FIG. 2, a characteristic curve LC-A is that of the liquid crystal material which has heretofore been used in an ordinary liquid crystal display device, while characteristic curves LC-B and LC-C are those of the liquid crystal materials each of which is used in the embodiment of the invention. The driving voltage obtained when the ratio of luminance during white display and that during black display which ratio represents the display quality of each of the liquid crystal display devices, i.e., a so-called contrast ratio, is 1:200 is defined as a threshold voltage V_{CR}200 of the liquid crystal.

From FIG. 2, the driving voltage of LC-A is 3.5 V. The driving voltage of LC-B is 2.5 V when the above-described contrast ratio (1:200) is taken into account. The use of a liquid crystal material having a driving voltage of 2.5 V or less offers two merits, one of which is a reduction in power consumption. According to the above expression (1), it can be seen that the driving voltage of LC-B enables the power consumption W to be reduced to about half, 2.5²/3.5²=0.5, with respect to the driving voltage of LC-A.

The other merit of the use of the liquid crystal material having a driving voltage of 2.5 V or less is that since a driver of electric strength 5 V can be used as a circuit for outputting the liquid crystal driving voltage, the manufacturing cost of the liquid crystal display device can be reduced to a great extent as compared with the use of a driver of high electric strength. Incidentally, from FIG. 2, when the liquid crystal material of LC-C is used, the power consumption can be reduced to about ⅕ and a drain driver of 3.3 V in electric strength can be used, whereby it is possible to achieve a far lower power consumption and a far lower manufacturing cost.

FIG. 3 is an explanatory view showing the relationship between liquid crystal driving voltage and relative transmissivity in terms of the twist angle of a liquid crystal. In the horizontal axis, V indicates the liquid crystal driving voltage V_{SIG}, while the vertical axis indicates a relative transmissivity plotted against a variation in the liquid crystal driving voltage V_{SIG} (V), where 1 indicates the transmissivity obtained when no liquid crystal driving voltage is being applied.

In FIG. 3, a characteristic curve LC-D shown by black dots and a characteristic curve LC-D shown by white dots show the cases where the twist angle was made 90° and 96°, respectively. The driving voltage obtained when the ratio of luminance during white display and that during black display which ratio represents the display quality of a liquid crystal display device, i.e., a so-called contrast ratio, is 1:200 is defined as a threshold voltage V_{CR}200 of the liquid crystal.

In FIG. 3, there is shown that the threshold voltage V_{CR}200 of LC-D is 2.95 V when the liquid crystal is twisted at 90°, and the threshold voltage V_{CR}200 of LC-D is 2.49 V when the liquid crystal is twisted at 96°. From FIG. 3, it can be seen that the driving voltage can be reduced by increasing the twist angle, and even the liquid crystal of LC-D that ordinarily cannot be driven at 2.5 V becomes able to be driven at 2.5 V by increasing the twist angle to 96° or more as in the case of the liquid crystal of LC-D.

The characteristics of a liquid crystal material itself will be described below. The threshold voltage Vₜₕ of the liquid crystal material is theoretically expressed by the following expression (2). Because lower threshed voltage=lower driving, the driving voltage of the liquid crystal material can be reduced by increasing its dielectric an isotropy Δε or decreasing its elastic constant K.

Vₜₕ=π(K/(ε₀·|Δε|))^{½}∝(K/Δε)^{½}, (2)

K=k₁₁+(k₃₃−2k₂₂)/4, (3)

where Vₜₕ: threshold voltage (V),

k₁₁: elastic constant of liquid crystal (N), (spray k₁₁, twist k₂₂, bend k₃₃)

ε₀: vacuum transmissivity (F/m), and

Δε: dielectric anisotropy of liquid crystal.

Ordinarily, since the dielectric anisotropy Δε can be more easily controlled than the elastic constant K, the driving voltage is reduced by increasing the dielectric anisotropy Δε.

However, this method has two problems. One of the problems is that as the dielectric anisotropy Δε is increased, the volume C_{LC} of the above expression (1) increases, so that power consumption increases. The other problem is that as the dielectric anisotropy Δε is increased, the resistivity of the liquid crystal tends to easily lower, so that defective display due to a lowering in voltage retention easily occurs.

Table 1 shows the relationship between the dielectric anisotropy Δε of the liquid crystal material and defective display.

TABLE 1
Relationship between dielectric anisotrophy Δε
of liquid crystal material and defective display due to
lowering in resistivity of liquid crystal

| Δε | 7 | 10 | 15 | 18 |
|---|---|---|---|---|
| Occurrence | Defective | Defective | Defective | Defective |
| of defective | display did | display did | display did | display |
| display | not occur | not occur | not occur | occurred |

(note) Evaluation after aging at 50° C. for 500 hours

As shown in Table 1, it has been confirmed that if the dielectric anistropy εε is 15 or less, defective display does not occur, but if the dielectric anisotropy Δε is 18, defective display occurs.

For this reason, the dielectric anisotropy Δε needs to be 15 or less, and is preferably made as small as possible in terms of power consumption.

FIG. 4 is an explanatory view showing the relationship between a driving voltage parameter DVP of the liquid crystal material and the measured value of the driving voltage. From FIG. 4, it can be seen that the driving voltage parameter DVP (Driving Voltage Parameter) and the measured value of the driving voltage are proportional to each other and the above expression (2) is satisfied.

Therefore, the driving voltage can be replaced with the DVP value calculated from the dielectric anisotropy Δε and the elastic constant K of the liquid crystal material. From FIG. 4, it can be seen that a liquid crystal material of driving voltage 2.5 V needs a DVP value of 0.8 pN.

FIG. 5 is an explanatory view showing the relationship between the driving voltage parameter DVP and the dielectric an isotropy Δε of the liquid crystal material. Since the elastic constant K (shown by black dots in FIG. 5) of an ordinary liquid crystal material which has heretofore been used is about 10 pN, the dielectric anisotropy Δε must be made approximately 15.5 if the driving voltage parameter DVP is to be made 0.8 or less to effect driving at 2.5 V.

As described previously, even if a lowering in driving voltage is achieved, the effect of lowering the power consumption becomes small owing to an increase in the liquid crystal volume C_{LC}, so that defective display easily occurs.

However, as in the case of the liquid crystal materials shown by black squares, black triangles and black diamonds in FIG. 5, if the elastic constant K is 8 pN or less, the dielectric anisotropy Δε is about 13 or less and driving at 2.5 V can be realized, whereby it is possible to realize a liquid crystal display device in which defective display does not occur and power consumption is small.

In the case of driving at 1.65 V, since the driving voltage parameter DVP is 0.55 pN from FIG. 4, by using a liquid crystal material in which the elastic constant K is approximately 4 pN and the dielectric anisotropy Δε is 13 or less, it is similarly possible to realize a liquid crystal display device in which defective display does not occur and power consumption is small.

However, a theoretical formula for response time τₒₙ is expressed by the following expressions (4) and (5), and it is desirable to make the elastic constant K 4 pN or more, because the response time τₒₙ becomes long if the elastic constant K is made excessively small.

τₒₙ=ηd²/(ε₀|Δε|V²−π²K), (4)

τ_{off}=ηd²/π²K, (5)

where τₒₙ: on response time (ms)

τ_{off}: off response time (ms)

η: viscosity of liquid crystal (mPa.s),

d: cell gap (μm), and

V: driving voltage (V).

According to the liquid crystal display device of the above-described embodiment, low voltage driving (low power consumption) is enabled without lowing contrast. In addition, since the dielectric anisotropy Δε of the liquid crystal material is not large, it is possible to restrain the occurrence of defective display due to a lowering in the resistivity of the liquid crystal.

Furthermore, since the volume of the liquid crystal layer is not large in spite of low voltage driving, it is possible to restrain an increase in power consumption due to an increase in the volume of the liquid crystal layer, whereby it is possible to provide a liquid crystal display device which is lowered in power consumption as a whole and can use drain drivers of low electric strength.

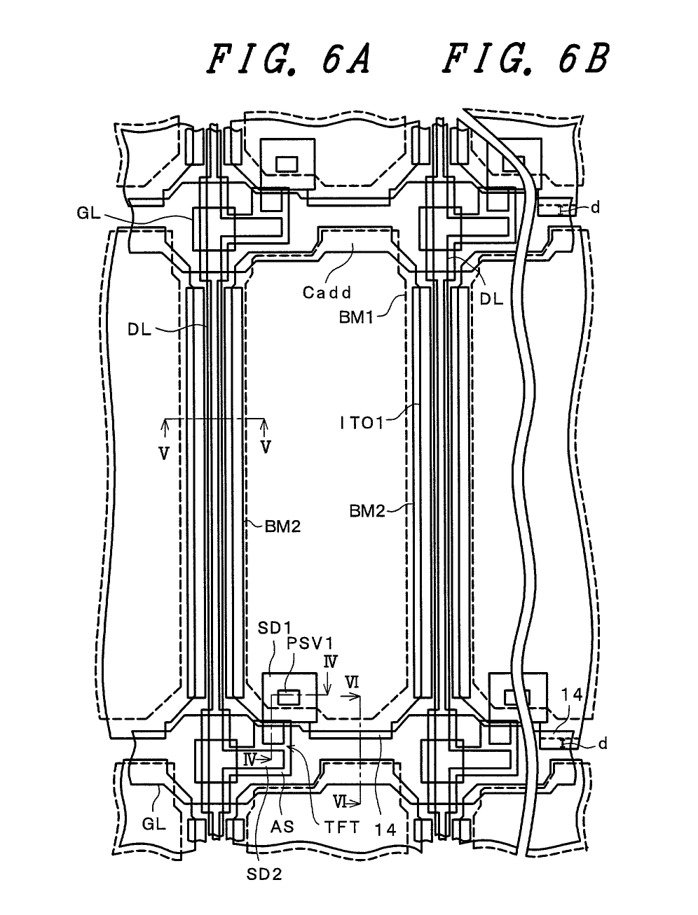

The details of an embodiment of a liquid crystal display device to which the invention is applied will be described below with reference to FIGS. 6A to 9.

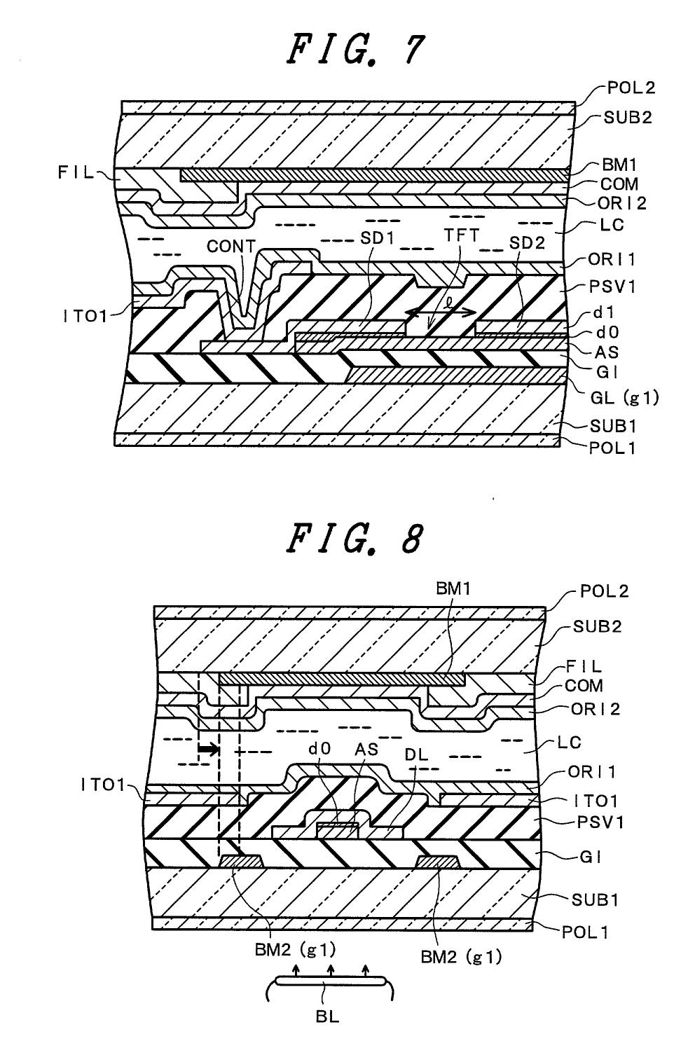

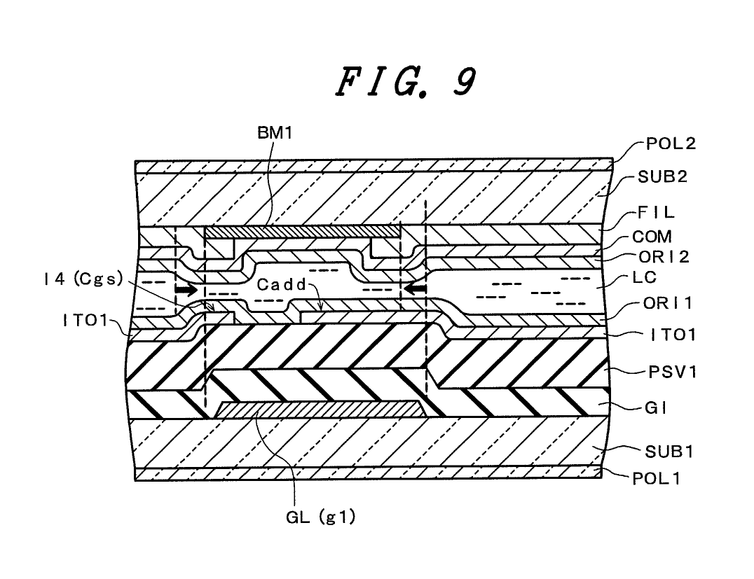

FIGS. 6A and 6B are plan views showing the construction of the periphery of one pixel of a liquid crystal panel which constitutes the liquid crystal display device according to the invention. FIG. 7 is a cross-sectional view taken along line IV-IV of FIG. 6A, FIG. 8 is a cross-sectional view taken along line V-V of FIG. 6A, and FIG. 9 is a cross-sectional view taken line VI-VI of FIG. 6A.

A thin film transistor TFT and a pixel electrode IT01 are formed on a thin film transistor substrate of this liquid crystal panel, and a color filter FIL and a first black matrix BM1 are formed on a color filter substrate of the liquid crystal panel.

A lower polarizer POL1 and an upper polarizer POL2 are respectively stacked on the outside surfaces of the thin film transistor substrate SUB1 and the color filter substrate SUB2. Gate lines GL which are disposed to be extended in the x direction (horizontal direction) and to be juxtaposed in the y direction are formed on the inside surface (a side which faces the liquid crystal LC) of the thin film transistor substrate SUB1.

Each of the gate lines GL is formed of a conductive layer g1 made of chromium, molybdenum, a chromium/molybdenum alloy, aluminum, tantalum, titanium or the like. Otherwise, a stacked film of such conductive layer may be used to decrease the wiring resistance of the gate lines GL. In the case where aluminum is used for the gate lines GL, an alloy to which a metal such as tantalum, titanium or niobium is added in a small amount may be used to eliminate the occurrence of projections such as hillocks or whiskers.

The pixel electrode IT01 made of a transparent conductive film IT0 is formed on a large portion of each pixel area surrounded by adjacent ones of the gate lines GL and adjacent drain lines DL.

A portion which lies over the gate line GL on the bottom left side of the pixel area as viewed in FIG. 6 is an area in which the thin film transistor TFT is formed. The thin film transistor TFT is formed in such a manner that the gate insulating film GI made of, for example, SiN, a semiconductor layer AS made of i-type amorphous Si, a semiconductor layer d0 made of amorphous Si containing an impurity, a drain electrode SD2 and a source electrode SD1 are stacked in that order.

The drain electrode SD2 and the source electrode SD1 are formed as the same time as the drain lines DL. As shown in FIG. 8, each of the drain lines DL is formed over the gate insulating film GI, the semiconductor layer AS and the semi conductor layer d0, and is formed of a single or stacked conductive layer made of chromium, molybdenum, a chromium/molybdenum alloy, aluminum, tantalum, titanium or the like.

The drain electrode SD2 of the thin film transistor TFT is integral with the drain line DL, and the source electrode SD1 is spaced apart from the drain electrode SD2 by a predetermined channel length I (FIG. 7).

A protective film (passivation film) PSV1 made of an insulating film is provided over the source electrode SD1 and the drain electrode SD2. This protective film PSV1 is a film of good moisture resistance, for example, an organic resin film such as silicon nitride SiN or polyimide.

A through-hole CONT is formed in the protective film PSV1 over the source electrode SD1 and electrically connects the pixel electrode IT01 and the source electrode SD1 to each other. As shown in FIG. 9, a charge-holding capacitance Cadd is formed which has one electrode using the gate line GL and the other electrode using the conductive layer formed at the same time as the pixel electrode IT01, as well as a dielectric using the gate insulating film GI and the protective film PSV1 interposed between the gate line GL and the pixel electrode IT01.

An alignment film ORI1 for restricting the initial alignment of the liquid crystal LC is formed on the entire surface of the pixel electrode IT01.

The first black matrix BM1, color filters FIL for three colors, a common electrode IT02 and an alignment film OR12 are formed on the inside surface of the color filter substrate SUB2 in the state of being stacked in that order.

In this embodiment, a second black matrix BM2 made of a light-shielding metal film is provided on the thin film transistor substrate SUB1 on which the drain line DL is formed. This second black matrix BM2 is formed of the same material as the conductive film g1 which constitutes the gate line GL, in the same layer as the gate line GL. As shown in FIGS. 6A and 6B, this second black matrix BM2 is formed to overlap the pixel electrode IT01 along the drain line DL, but not to overlap the drain line DL. The cross-sectional structure of the second black matrix BM2 is as shown in FIG. 8.

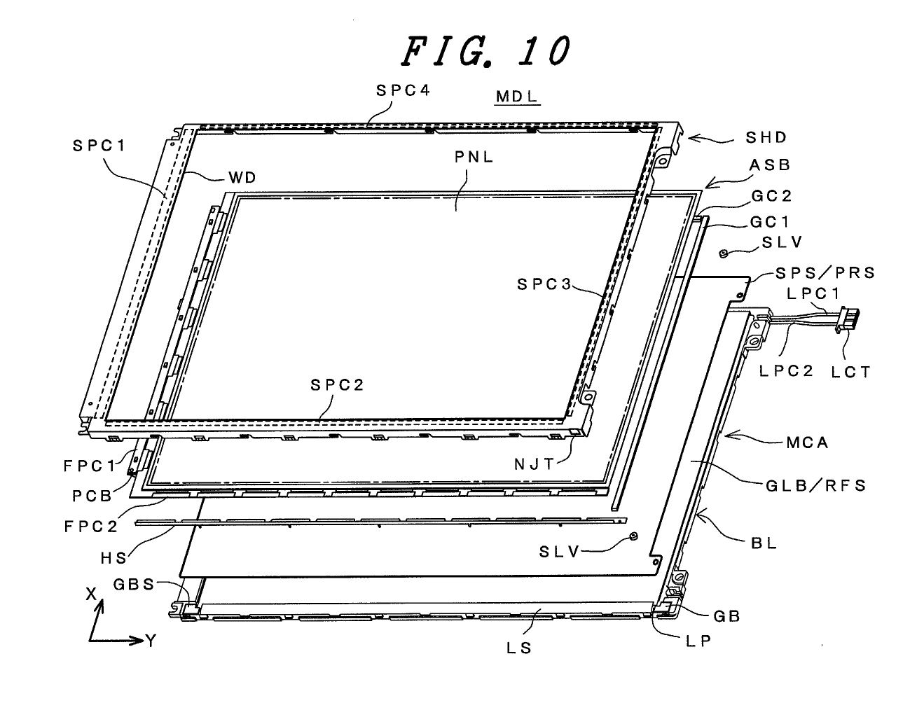

FIG. 10 is a developed perspective view for explaining a specific example of the construction of the liquid crystal display device according to the invention. This liquid crystal display module MDL is constructed as follows. Sign SHD denotes an upper frame made from a metal plate, sign WD denotes a display window, signs SPC1 to SPC4 denote insulative spacers, signs FPC1 and FPC2 denote multi layered flexible circuit boards (symbols FPC1 and FPC2 denote a gate side circuit board and a drain side circuit board, respectively), sign HS denotes a frame ground made of a metal foil and disposed to provide electrical connection between the ground of the drain side circuit board FPC2 and the shield case SHD, sign PCB denotes an interface circuit board, sign ASB denotes an assembled liquid crystal panel having driver circuit boards, sign PNL denotes a liquid crystal panel (a thin film transistor substrate and a color filter substrate) which includes two glass substrates superposed on each other with driver ICs being mounted on either one of the two, signs GC1 and GC2 denote rubber cushions, sign PRS denotes a prism sheet (in this embodiment, the prism sheet PRS is made of two optical sheets), sign SPS denotes a diffusion sheet, sign GLB denotes a light guide plate, sign RFS denotes a reflecting sheet, sign SLV denotes sleeves for securing the diffusion sheet SPS and the prism sheet PRS, sign MCA denotes a lower case (molded case) formed by integral molding, sign LP denotes a fluorescent tube, sign LS denotes a reflector which reflects light of the cold cathode fluorescent tube LP toward the light guide plate GLB, signs LPC1 and LPC2 denote lamp cables, sign LCT denotes a connector for connection to an inverter, and signs GB denote rubber bushes which support the cold cathode fluorescent tube LP.

Sign BL denotes a backlight structure made of the fluorescent tube LP, the reflector LS, the light guide plate GLB, the reflecting sheet RFS, the diffusion sheet SPS and the prism sheet PRS. This backlight structure BL is provided for supplying uniform light to the reverse surface of the liquid crystal panel PNL so that an observer who sees the liquid crystal panel PNL from the obverse surface thereof can recognize a variation in the optical transmissivity of the liquid crystal as an image display.

As shown in FIG. 10, the lower case MCA, the backlight BL, the liquid crystal display element ASB having driver circuit boards, the shield case SHD and the like are stacked to assemble the liquid crystal display module MDL.

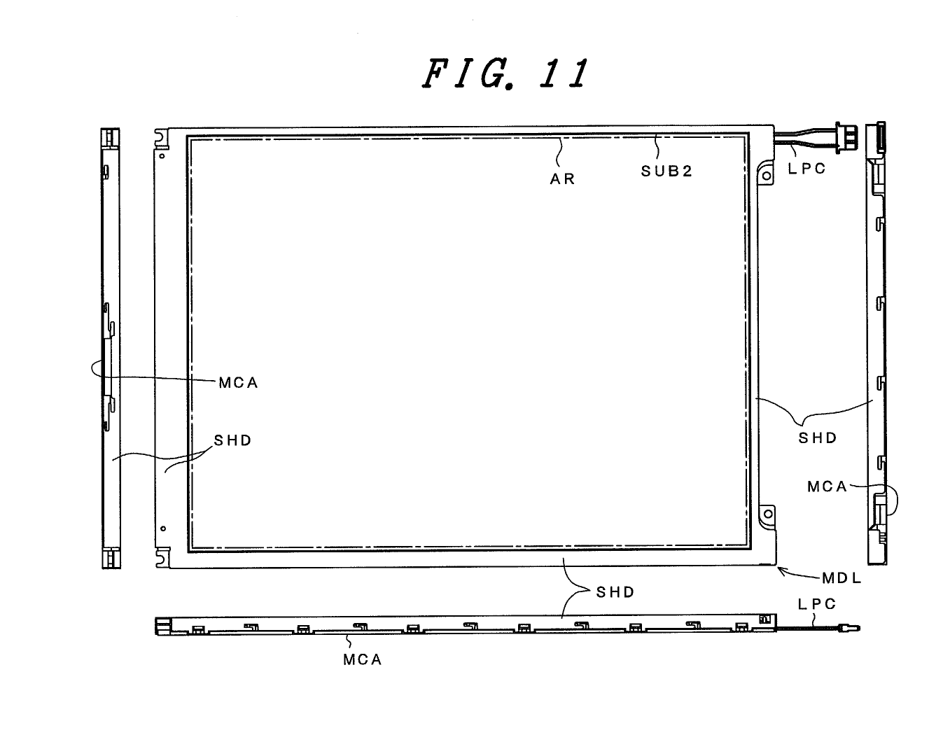

FIG. 11 is a front view and a side view of the liquid crystal display device according to the invention. The area exposed in the display window WD of the upper frame SHD is a display area AR in which to display an image, and a polarizer is provided on the outermost surface of the display area AR. The upper frame SHD and the lower frame MCA are secured by the caulking of craws. The cold cathode fluorescent tube LP which constitutes the backlight structure BL is accommodated in the interior of the upper side of the liquid crystal display module MDL, and lamp cables LPC for supplying electricity are led from the upper side.

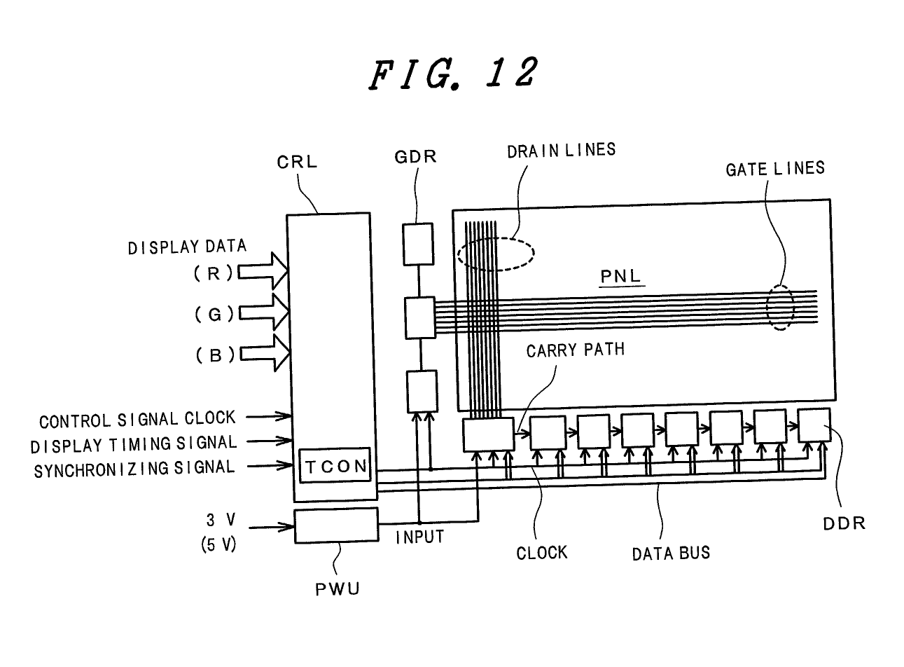

FIG. 12 is an explanatory view of the construction and the driver system of a general liquid crystal display device to which the invention is applied. This kind of liquid crystal display device has a liquid crystal panel PNL, drain drivers DDR which are driver circuits (semiconductor chips) for driving data lines (also called drain signal lines or drain lines), and gate drivers GDR which are driver circuits (semiconductor chips) for driving scanning lines (also called gate signal lines or gate lines), on the periphery of the liquid crystal panel PNL. The liquid crystal display device is also provided with a power supply circuit PWU and a display control device CRL which is a display control part for supplying display data for displaying an image, clock signals and gray scale voltages and the like to the drain drivers DDR and the gate drivers GDR.

Display data from an external signal source (host) such as a computer, a personal computer or a television receiver circuit as well as a control signal clock, a display timing signal and a synchronizing signal are inputted to the display control device CRL. The display control device CRL is provided with a gray scale reference voltage generating part, a timing controller TCON and the like, and converts the display data supplied from the outside into data of the type which conforms to the format of display on the liquid crystal panel PNL.

Display data and clock signals for the gate drivers GDR and the drain drivers DDR are supplied as shown in FIG. 12. A carry output from each of the drain drivers DDR is applied to the carry input of the next one on an unmodified basis.

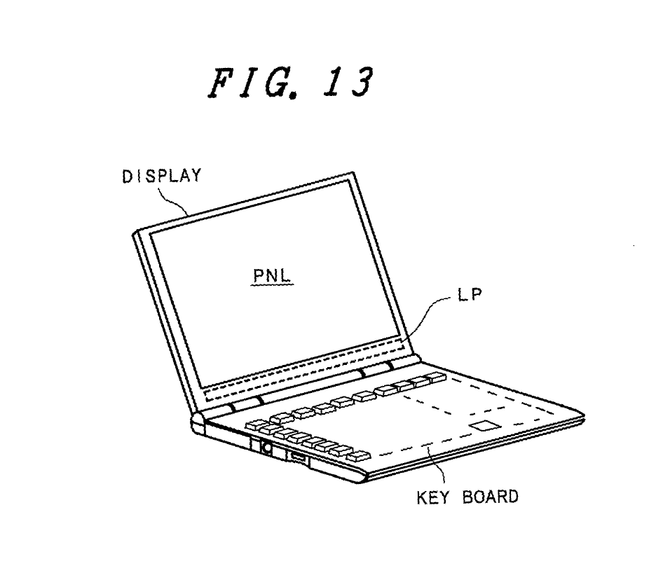

FIG. 13 is a view of the external appearance of a notebook personal computer which is one example of an electronic apparatus having a liquid crystal display device according to the invention. This notebook personal computer has a body provided with a keyboard section, and a liquid crystal panel which is mounted in its display section and constitutes the liquid crystal display device uses the liquid crystal material described above in connection with the embodiments.

The liquid crystal display device according to the invention is not limited to the notebook personal computer shown in FIG. 13, and it goes with out saying that the liquid crystal display device can be similarly applied to display monitors, television receivers or display devices for other kinds of equipment.

In addition, the invention is not applied to only the above-described active matrix type of liquid crystal display device, but the present invention can also be similarly applied to a liquid crystal display device using a simple matrix type of liquid crystal panel.

As described above, in accordance with the invention, low voltage driving (low power consumption) is enabled without lowering contrast, and since a dielectric anisotropy Δε of a liquid crystal material is not large, it is possible to restrain the occurrence of defective display due to a decrease in the resistivity of the liquid crystal.

In addition, since the volume of the liquid crystal layer is not large in spite of low voltage driving, it is possible to restrain an increase in power consumption due to an increase in the volume of the liquid crystal layer, whereby it is possible to provide a liquid crystal display device which is lowered in power consumption as a whole and can use drain drivers of low electric strength.

What is claimed is:

1. A liquid crystal display device comprising a liquid crystal panel in which a liquid crystal compound layer is interposed between one substrate on which pixel electrodes are formed and another substrate on which common electrodes are formed, and the transmissivity of light being transmitted through the liquid crystal compound layer is modulated by applying a voltage across the pixel electrodes and the common electrodes,
wherein the dielectric anisotropy Δε of the liquid crystal compound layer is 15 or less, the elastic constant K of the liquid crystal compound layer is 8 pN or less, and the maximum value of the liquid crystal driving voltage applied across the pixel electrodes and the common electrodes is 3 V or less.

2. A liquid crystal display device according to claim 1, wherein the dielectric anisotropy Δε of the liquid crystal compound layer is 15 or less, the elastic constant K of the liquid crystal compound layer is 7 pN or less and 4 pN or more.

3. A liquid crystal display device according to claim 1 or 2, wherein the ratio of transmissivity when the liquid crystal driving voltage is not being applied and transmissivity when the liquid crystal driving voltage is at the maximum value is 1:200 or more.

4. A liquid crystal display device according to claims 1 to 3, wherein polarizers are respectively disposed in a crossed-Nicols manner on main surfaces of the substrates that are opposite to the liquid crystal compound layer.
